(19) United States
(12) Patent Application Publication
(10) Pub. No.: US 2014/0289049 A1
(43) Pub. Date: Sep. 25, 2014

(54) COMMUNICATION SYSTEM FOR THE DISPLAY OF ADVERTISEMENTS

(71) Applicant: Bruno Van Boucq, Beauvechain (BE)

(72) Inventor: Bruno Van Boucq, Beauvechain (BE)

(73) Assignee: PROXISTORE S.A., Bruxelles (BE)

(21) Appl. No.: 14/352,334

(22) PCT Filed: Oct. 19, 2012
(86) PCT No.: PCT/EP2012/070789

§ 371 Date: Apr. 17, 2014

(30) Foreign Application Priority Data
Oct. 20, 2011 (EP) 11185958.3

(51) Int. Cl. G06Q 30/02

(52) U.S. Cl. CPC G06Q 30/0261
USPC 705/14.58

(57) ABSTRACT

Communication system for displaying advertisements, characterized in that it comprises a cascade geolocation system.

The present invention relates to a communication system.

Non-intrusive secondary advertisements, open by default, are known for announcing goods and services on the Internet when the user goes to particular pages to which these advertisements are linked. This allows advertisers, who possibly sponsor the website where their advertising appears, to broadcast an advertisement that will appear on the internet user's screen.

However, in most cases these advertisements relate to national retailers and suppliers of services that the internet user can only locate precisely after undertaking additional search steps. For example, after viewing the advertisement (publicity) and if the latter is of interest to the internet user, the latter must, on the basis of the information mentioned in the advertisement, consult a map (plan) for locating the advertiser or at least his point of sale more precisely. Thus, the internet user is often led to receive and view advertisements from advertisers whose points of sale can be relatively remote from the place where he is located at the time when the advertisement is displayed. This is neither of benefit to the internet user, who generally has no interest in making his way to a distant point of sale, nor to the advertiser, whose advertisement does not have any real impact on internet users located at too great a distance from his point of sale.

That is why geolocation systems were developed, with the aim of locating the Internet user as precisely as possible in order to send him advertisements that are as relevant as possible, i.e. advertisements from advertisers whose points of sale are close to his location.

Such a system is known for example from document US2008/313039. The system disclosed in that document is based on the fact that the internet user himself sends a request to a data processing server so that he is sent advertisements relating to a geographic zone corresponding to his location, which he himself defines. Thus, an advertisement will only be broadcast following the request from the internet user, which, in terms of broadcasting of an advertisement, is relatively restrictive from the advertiser's standpoint.

In the interests of the advertiser, but also so that the Internet user receives advertisements corresponding better to his location, other systems have been developed. For example, document JP2002312669 discloses a system for broadcasting advertisements based on the Internet address or IP address (“Internet Protocol Address”) of the Internet user, this address corresponding to an identification number assigned permanently or temporarily to each device connected to a computer network using the “internet protocol” (communication protocol designed for use by the internet). Geolocation of the internet user is therefore carried out based on his IP address and advertisements are sent to him and are displayed on his screen even without specific request on his part. For the advertiser, this system is more suitable since his advertisement is sent to localized Internet users. Moreover, as his advertisement is more relevant as regards the Internet user's location, it has much more chance of arousing the latter's interest.

Unfortunately, this geolocation of the internet user according to his IP address is imprecise and does not allow location of the Internet user at the exact place where he is located. In fact, the IP address of an internet user depends on the Internet provider, who does not necessarily always link this address to the precise place where the internet connection is located. For example, it is not unusual for the Internet user to be located in a radius of several kilometres when his IP address is used for this purpose.

There is therefore a real need to develop a system for locating precisely, i.e. in a radius of the order of a few metres, an Internet user so that the latter receives targeted advertisements linked to points of sale near his location, the aim being to allow advertisers to broadcast advertisements in restricted and small geographic zones (of the order of a few metres) according to the Internet user's location.

That is why one object of the present invention is to provide a communication system that allows an internet user to be directed towards local advertising campaigns.

A second object of the present invention is to provide a communication system that allows a retailer or a supplier of services to advertise his goods and/or service(s) to an internet user in a zone that is predetermined by the retailer or the supplier of services.

Another object of the present invention is to provide a communication system through which the advertiser can subscribe to a service that enables him to have direct control over his advertising.

Moreover, according to a first aspect of the invention, it is envisaged that precise geolocation of the Internet user will be achievable in 100% of cases.

Furthermore, according to another aspect of the present invention, it is envisaged that the choice of the advertisement that will be displayed on the screen (advertising window) will be automatic and carried out according to an algorithm taking into account the number of times that the advertisement has been distributed per day, from the remaining budget advanced by the advertiser for a given advertisement and the distance between the retailer or the supplier of services mentioned in the advertisement and the internet user.

To solve the problems mentioned above and to meet the aims of the present invention, a communication system is envisaged according to the invention for displaying advertisements, characterized in that it comprises a cascade geolocation system comprising at least one of the following steps allowing precise geolocation of the internet user:
geolocation is carried out via the IP address of the connection of said Internet user to a computer network;
geolocation is carried out via an internet browser of said Internet user and a location service of this internet browser; and
geolocation is carried out by said internet user, who agrees to enter his precise location.

Such a communication system makes geolocation of an internet user possible in 100% of cases since it is not limited to a single means of geolocation but is based on several independent means making it possible, in all instances, to locate (determine the position of) the internet user. Location based on the IP address (location for example via a Maxmind® correspondence database—Maxmind of Waltham, Mass., USA) will only be applied if the other means employed have not allowed the internet user to be located precisely. Moreover, the Internet user will only be asked to give his location himself if the other means of geolocation cannot be applied.

Location that is effected via the Internet browser and the location service of this internet browser can be based, for example, on “Google Service Location®” (Google Inc., Mountain View, USA) or on “Microsoft Service Location®” (Microsoft Corporation, Redmond, USA) or on the “Apple Location Service®” (Apple Inc., California, USA) or else on other location services.

Internet browsers such as Chrome® (Google Inc., Mountain View, USA), Firefox® (Mozilla Foundation, SeaMonkey, Mountain View, USA) and Opera® (Opera Software, Oslo) use more particularly the location service of “Google Location®” (Google Inc., Mountain View, USA).

The Internet browser “Internet Explorer®” (Microsoft Corporation, Redmond, USA) uses more particularly the location service of “Microsoft Location®” (Microsoft Corporation, Redmond, USA).

The internet browser “Safari®” (Apple Inc., California, USA) uses more particularly the location service of “Apple Location®” (Apple Inc., California, USA).

Of course, other internet browsers as well as other location services associated with these internet browsers can be considered in the context of the present invention.

The location services make it possible to identify at least one SSID (Service Set Identifier or name of a wireless network corresponding to a unique number) and/or identify the IP address and/or collect information on the 3G (third generation) transmission tower and/or define the GPS (“Global Positioning System”) and/or GPRS (“General Packet Radio Service”) coordinates of said internet user. These location services can therefore supply one or more of these pieces of information (IP, SSID, 3G, GPS) depending on the internet browser.

Preferably, according to the invention, the markup language system for web page creation is an HTML 5.0 language system or a higher version of an HTML (“Hypertext Markup Language”) language system. However, if an older markup language (for example the HTML 4 language) is implemented in a browser support (computer, data tablet, smartphone, etc.), the internet user will still be geolocated at the minimum via his IP address.

Moreover, such a communication system allows advertisers to effect geolocated communication of their messages to their clients surfing very familiar internet sites with large audiences but also allows surfers (internet users) to obtain local commercial information in a non-intrusive format, said commercial information being displayed on their favourite websites.

Advantageously, according to the invention, the communication system is suitable for at least one of fixed and portable computers, data tablets, mobile phones (smartphones), systems equipped with a Wi-Fi system, digital televisions and radios, this list not being exhaustive.

Other forms of the communication system according to the invention are indicated in the appended claims.

The invention also relates to a method of communication for displaying advertisements intended for the internet user, characterized in that it is based on an operating scheme comprising the following steps:
geolocating said internet user;
selecting an advertisement corresponding to the geolocation of said internet user;
calling said advertisement on the website consulted by said internet user;
displaying said advertisement according to the geolocation of the internet user.

Preferably, according to the present invention, said selecting of an advertisement is carried out according to an algorithm where at least one of the following parameters is/are taken into account: (1) the number of times that the advertisement has been broadcast per day, (2) the remaining budget advanced by the advertiser for a given advertisement and (3) the distance between the retailer or supplier of services mentioned in the advertisement and the internet user.

Other forms of the method of communication according to the invention are indicated in the appended claims.

The invention also relates to a communication tool, characterized in that it allows the advertiser or the supplier of services to create or modify an advertisement according to the following steps:
defining a zone for broadcasting an advertisement,
formatting said advertisement,
determining the time slots for broadcasting said advertisement,
validating the data introduced and the parameters defined in the preceding steps.

Preferably, according to the invention, said defining of a zone for broadcasting an advertisement is carried out by means of at least one tag or circle or by selecting several zones, for example municipalities.

By defining the broadcasting zone, it is possible to define precisely the place to which the advertisement relates by means of a tag or by directly encoding an address or the geographic coordinates (latitude and longitude) or postcodes (municipalities). Once the place to which the advertisement relates is precisely defined, the advertiser or the supplier of services can define a broadcasting zone (radius of action) in which the advertisement is distributed. Later on, the advertiser will be able to decide to expand or restrict the geographic zone or broadcasting zone initially defined.

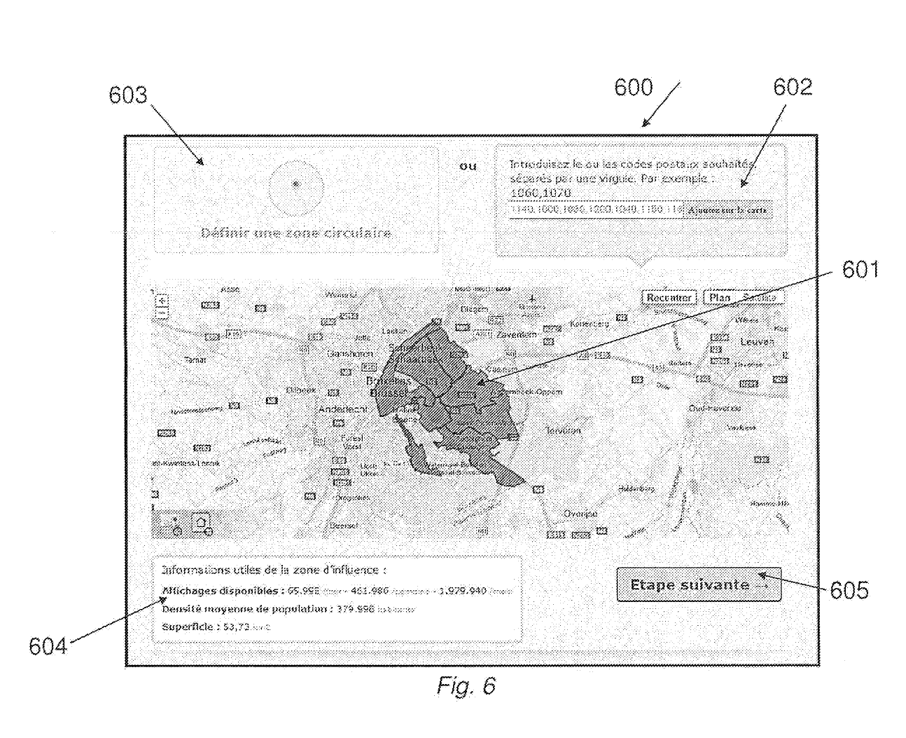

The advertiser can decide to define the broadcasting zone according to a circle, for example by using an adjustment bar for the radius of a circle, or by applying the advertisement and therefore the broadcasting zone to several municipalities, for example by entering several postcodes (see FIG. 6). During selection of a broadcasting zone, it is envisaged, according to the invention, that additional information is supplied to the advertiser, such as the population density for the zone selected, the area involved (in km²) or else the number of potential viewings per day or per month. Advantageously, such parameters allow the advertiser to better evaluate the budget required for broadcasting his advertisement in a given zone.

Advantageously, according to the invention, said formatting of said advertisement allows the insertion of an image in any format or insertion of a video. In fact, the advertiser can insert an image in any format (for example in .png, .gif or .jpg, etc., format) in his advertisement, but also define a title, add text, add a video (.gif animation, etc.) or else add a URL (“Uniform Resource Locator”) link to a website.

Preferably, said determination of the time slots for broadcasting said advertisement makes it possible to define the days and the times for broadcasting said advertisement (time slots).

Management of the advertisement created allows management of the advertisement at any time, editing, archiving, copying, stopping it or else consulting statistics relating to the advertisement (number of times displayed, number of clicks on a URL link, etc.). Parameters such as the dates of the start and finish of the advertisement can for example easily be modified, like the parameters of the advertiser's account (name, address, VAT number, etc.)

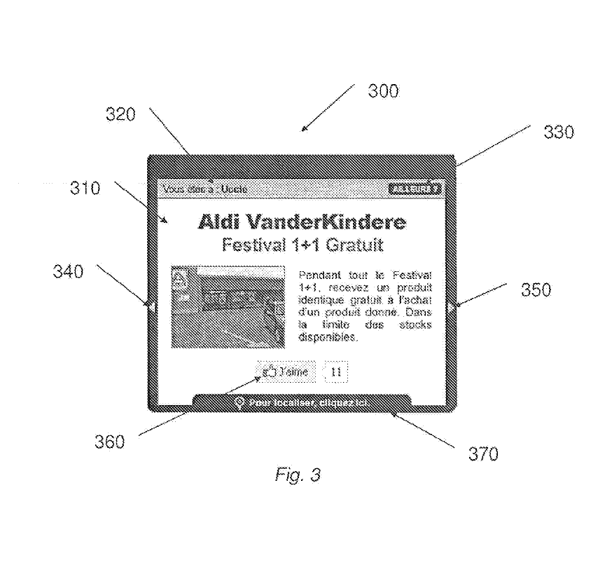

Thus, the present invention provides a real service for the supplier of services and for the advertiser. This service makes it possible to restrict the budget per day; to create, suspend, modify or re-launch the campaign in real time on a platform of the service provider; to consult in real time his advertising campaign and his customer catchment areas (geographic zone of influence of a shop); to consult in real time the results per advertisement (for example the number of printings of the advertisement, the number of clicks and the number of Facebook “likes”—Facebook Inc. of Palo Alto, Calif.) (see FIG. 3); and to extend the advertising campaign to online purchases on the service provider's platform.

Moreover, the supplier of services and the advertiser can choose the sites, can choose the days and times of broadcasting and can choose the extent of the zones of his advertisement.

Other forms of the communication tool according to the invention are indicated in the appended claims.

The present invention also relates to the use of a communication tool for displaying advertisements directed at internet users.

In fact, the communication tool according to the present invention can be used for distributing any advertisement, for example during local government elections or for any other non-commercial organization (for example a welcome page of a website of a given town) in parallel with the broadcasting of commercial advertisements allowing the supplier of services and the advertiser to advertise their merchandise and their services.

Other forms of use of the communication tool according to the invention are indicated in the appended claims.

Other features, details and advantages of the invention can be seen from the description given below, non-exhaustively and referring to the appended drawings.

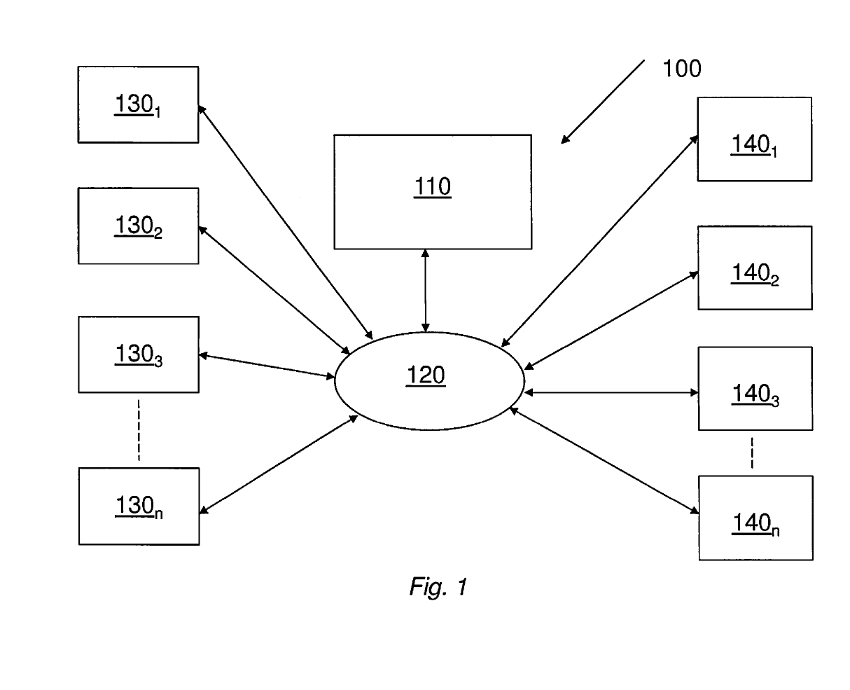

FIG. 1 illustrates a scheme of a communication system according to the present invention;

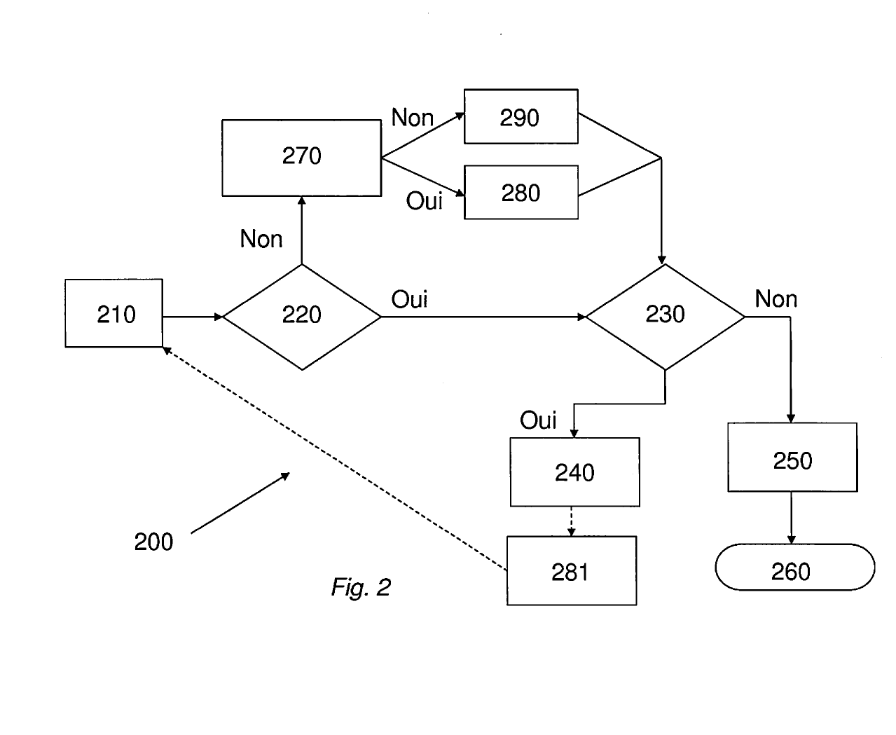

FIG. 2 illustrates an operating scheme of a communication system according to the present invention.

FIG. 3 illustrates the display of an advertising window according to the communication system according to the present invention.

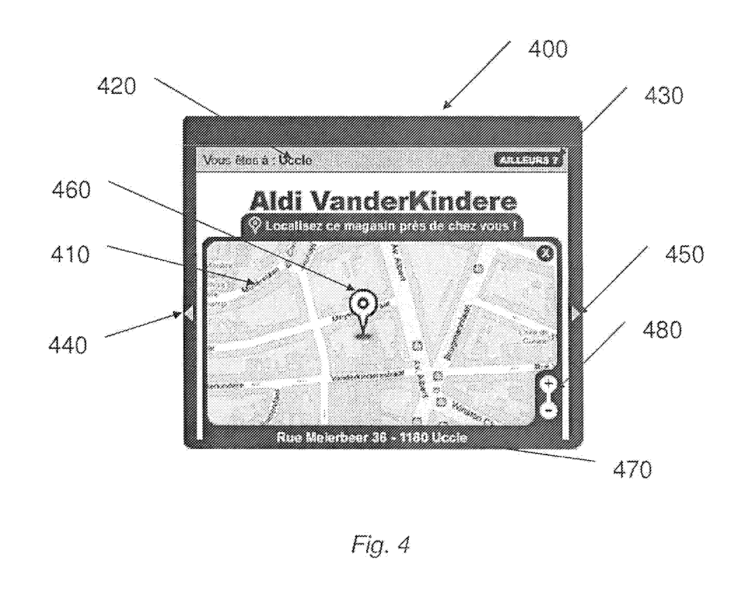

FIG. 4 illustrates another advertising window according to the communication system according to the present invention.

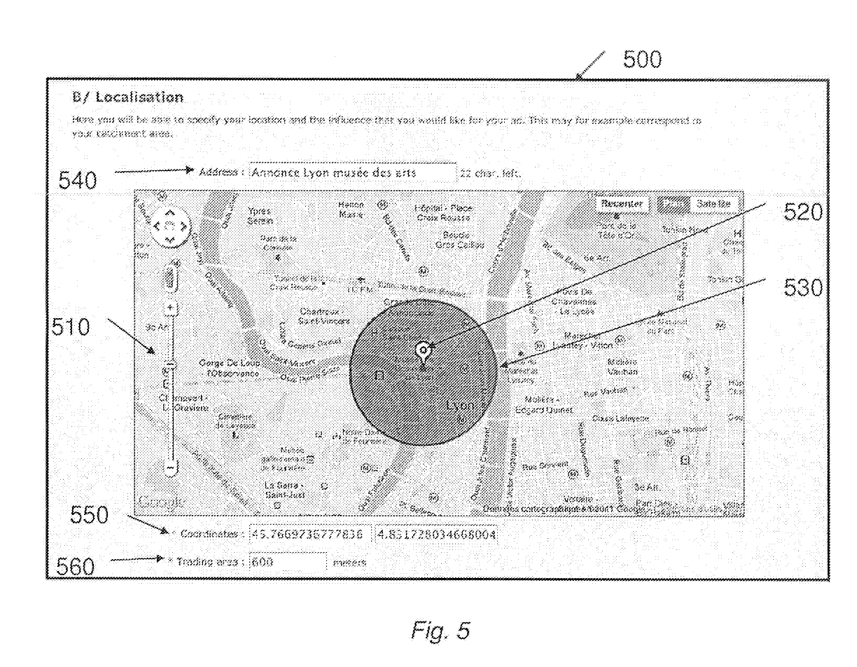

FIG. 5 illustrates a first tool allowing the advertiser to define the broadcasting zone of the advertisement.

FIG. 6 illustrates a second tool allowing the advertiser to define the broadcasting zone of the advertisement.

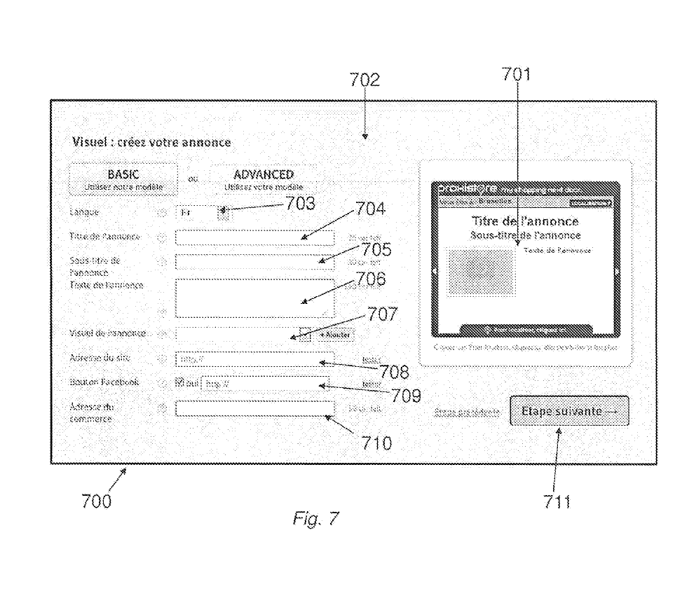

FIG. 7 illustrates a tool that allows the advertiser to create his advertisement by defining a series of parameters.

FIG. 1 illustrates a communication system 100 according to the present invention. The system 100 can be regarded as comprising a platform of a service provider 110 that constitutes the internet interface 120 for providing a platform (not shown) with which a plurality of service providers and advertisers 130₁, 130₂, 130₃, . . . , 130ₙ (the letter n can be any digit) can interact. A plurality of internet users 140₁, 140₂, 140₃, . . . , 140ₙ (the letter n can be any digit) surfing and using the internet 120 can access the information “posted” by a supplier of services or an advertiser 130₁, 130₂, 130₃, . . . , 130ₙ on the various partner sites via internet 120. The information “posted” preferably comprises local information, which is information relating to a particular geographic zone defined by geographic coordinates (longitude and latitude) predetermined by each internet user 140₁, 140₂, 140₃, . . . , 140ₙ. Depending on the geolocation of each Internet user 140₁, 140₂, 140₃, . . . , 140ₙ, different information can be supplied by the service provider 110 according to the subscription conditions to which each supplier of services or advertiser 130₁, 130₂, 130₃, . . . , 130ₙ has subscribed.

Even though FIG. 1 shows that the service provider 110 interacts with the supplier of services or advertiser 130 via the internet 120, it is envisaged, according to the present invention, that the service provider 110 and supplier of services or advertiser 130 can interact in other ways, for example by letter, by telephone, by email, etc.

FIG. 2 illustrates an operating scheme 200 of a communication system according to the present invention.

According to a first route according to the operating scheme 200, following calling of the advertising window 210 on the website consulted by the internet user, the communication protocol HTTP (hypertext transfer protocol) 220 is checked by the internet browser to determine whether the Internet user has already been geolocated previously and already possesses a cookie (evidence of connection), which makes it possible to determine whether the geolocation of said internet user is already recorded in a browser support, for example a fixed or portable computer, a data tablet or else a mobile phone. If the internet user has already been previously geolocated and if his geolocation has already been recorded in the communication system, said communication system will directly verify in the database comprising the advertisements 230 whether a local advertisement 240 can be displayed according to the precise geolocation of the internet user. If the internet user's geolocation corresponds to a local advertisement 240, then this local advertisement 240 will be displayed.

Optionally, following the display of said local advertisement 240, if the internet user so desires, he can, by clicking on a button (“other location”) that directs him to a platform where he can modify the existing cookie, modify his location more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local advertisement corresponds to the internet user's geolocation, then the communication system will go to a secondary program 250, which will allow a national advertisement 260 to be displayed.

According to a second route according to the operating scheme 200, following calling of the advertising window 210 on the website consulted by the internet user, the HTTP communication protocol 220 is checked by the internet browser to determine whether the internet user has already been geolocated previously and already possesses a cookie (evidence of connection), which makes it possible to determine whether the geolocation of said internet user is already recorded in a browser support, for example a fixed or portable computer, a data tablet or else a mobile phone. If the internet user has not yet been geolocated previously and if consequently his geolocation is not yet known by the internet browser, said Internet browser will display a pop-up (message) 270 asking said internet user whether he wants to be geolocated. If said internet user refuses to be geolocated, the communication system will even so locate the internet user according to the IP address 290 of his connection to a computer network, which leads to the creation of a cookie, whose lifetime is variable depending on the browser support. Following this geolocation of the internet user according to his IP address 290, said communication system will directly verify in the database comprising the advertisements 230 whether a local advertisement 240 can be displayed according to the precise geolocation of the internet user. If the internet user's geolocation corresponds to a local advertisement 240, then this local advertisement 240 will be displayed.

Optionally, following the display of said local advertisement 240, if the internet user so desires he can, by clicking on a button (“other location”) that directs him to a platform where he can modify the existing cookie, modify his location more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local advertisement corresponds to the internet user's geolocation, then the communication system will go to a secondary program 250, which will allow a national advertisement 260 to be displayed.

According to a third route according to the operating scheme 200, following calling of the advertising window 210 on the website consulted by the internet user, the HTTP communication protocol 220 is checked by the internet browser to determine whether the Internet user has already been geolocated previously and already possesses a cookie (evidence of connection), which makes it possible to determine whether the geolocation of said internet user is already recorded in a browser support, for example a fixed or portable computer, a data tablet or else a mobile phone. If the internet user has not yet been geolocated previously and if consequently his geolocation is not yet known by the Internet browser, said internet browser will display a pop-up (message) 270 asking said internet user whether he wants to be geolocated. If said internet user accepts being geolocated, this geolocation is carried out via the internet browser and its location service (280) making it possible to identify at least one SSID and/or identify the IP address and/or collect information on the 3G transmission tower and/or define the GPS and/or GPRS coordinates of said internet user. Acceptance of pop-up 270 leads to the creation of a cookie, whose lifetime is variable depending on the browser support. Following this geolocation of the internet user, said communication system will directly verify in the database comprising the advertisements 230 whether a local advertisement 240 can be displayed according to the precise geolocation of the internet user. If the Internet user's geolocation corresponds to a local advertisement 240, then this local advertisement 240 will be displayed.

Optionally, following the display of said local advertisement 240, if the Internet user so desires he can, by clicking on a button (“other location”) that directs him to a platform 281 where he can modify the existing cookie, modify his location more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local advertisement corresponds to the internet user's geolocation, then the communication system will go to a secondary program 250, which will allow a national advertisement 260 to be displayed.

FIG. 3 illustrates an advertising window 300 according to the present invention. It is to be understood that the format of this advertising window is given as an example and that it does not limit the scope of the present invention to this format alone. According to the invention, this advertising window 300 comprises the advertisement 310 of the advertiser or of the supplier of services, statement of the location 320 of the internet user, a link 330 allowing the internet user's location to be modified, arrows 340, 350 for moving onto another advertisement or for returning to a previous advertisement already viewed, a link 360 for indicating “like” on Facebook and a link 370 for viewing the precise location of the advertiser or of the supplier of services to which the advertisement 310 relates.

FIG. 4 illustrates the advertising window 400 that appears when the internet user makes use of link 370 for viewing the precise location of the advertiser or of the supplier of services to which the advertisement 310 relates. This advertising window 400 comprises a map 410 for locating the advertiser or the supplier of services, statement of the location 420 of the Internet user, a link 430 allowing the internet user's location to be modified, arrows 440, 450 for moving onto another advertisement or for returning to a previous advertisement already viewed, a tag 460 precisely stating the location of the advertiser or of the supplier of services, statement of the precise address 470 of the advertiser or of the supplier of services and a button 480 for zooming in or out in the map 420 in order to facilitate locating the advertiser or the supplier of services.

FIG. 5 illustrates a tool 500 that allows the advertiser or the supplier of services to define the precise place covered by his advertisement by identifying it either using a tag 520 on a map 510, or by entering the address 540 of said place, or by entering the geographic coordinates 550 of said place. Once said place is precisely defined, said tool allows the advertiser or the supplier of services to define the broadcasting zone 530 of his advertisement by defining a broadcasting zone 530 by postcode or with a circle. The broadcasting zone 530 can be located around the place to which the advertisement relates or elsewhere depending on the advertiser's target. The extent of the broadcasting zone as a circle is defined in metres 560. Even though FIG. 5 illustrates a circular zone of action around the place to which the advertisement relates, it is understood that this circular shape of the zone of action does not limit the present invention and that this zone can be, for example, of triangular or rectangular shape, etc.

FIG. 6 illustrates a tool 600 that allows the advertiser or the supplier of services to define the place or the broadcasting zone 601 relating to his advertisement according to the input of postcodes 602. The possibility of defining a circular zone is still offered 603. A frame 604 allows the advertiser to obtain additional information such as the number of displays available in the zone defined (per day, per week and per month), the average population density in the zone defined and the area of the zone defined. A button 605 allows the advertiser to pass to the next step of creating his advertisement, once the broadcasting zone 601 is defined.

FIG. 7 illustrates a tool 700 allowing the advertiser to create his advertisement by defining a series of parameters. This tool 700 comprises a first zone 701 and a second zone 702. The first zone 701 allows the advertiser to visualize his advertisement according to the parameters that he enters in the second zone 702. Several text zones 703 to 710 allow the advertiser to define a whole series of parameters: language, title of the advertisement, subtitle of the advertisement, text of the advertisement, visual of the advertisement (image), URL address of a website, Facebook button, address of the business (point of sale). A button 711 allows the advertiser to pass to the next step of creating his advertisement.

It is of course understood that the present invention is not limited in any way to the embodiments described above and that many changes can be made to it while remaining within the scope of the appended claims.

1. Communication system for displaying advertisements, characterized in that it comprises a cascade geolocation system comprising at least one of the following steps allowing precise geolocation of the internet user:
geolocation is carried out via the IP address of the connection of said internet user to a computer network;
geolocation is carried out via an internet browser of said internet user and a location service of this internet browser; and
geolocation is carried out by said internet user, who agrees to enter his precise location.

2. Communication system according to claim 1, characterized in that it is suitable for at least one of fixed and portable computers, data tablets, mobile phones (smartphones), systems equipped with a Wi-Fi system, digital televisions and radios.

3. Method of communication for displaying advertisements intended for the internet user, characterized in that it is based on an operating scheme comprising the following steps:
geolocating said internet user;
selecting an advertisement corresponding to the geolocation of said internet user;
calling said advertisement on the website consulted by said internet user;
displaying said advertisement according to the geolocation of the internet user.

4. Method of communication according to claim 3, characterized in that said selecting of an advertisement corresponding to the geolocation of said internet user is carried out according to an algorithm where at least one of the following parameters is taken into account: (1) the number of times that the advertisement has been broadcast per day, (2) the remaining budget advanced by the advertiser for a given advertisement and (3) the distance between the retailer or supplier of services mentioned in the advertisement and the internet user.

5. Communication tool, characterized in that it allows the advertiser or the supplier of services to create or modify an advertisement according to the following steps:
defining a zone for broadcasting an advertisement,
formatting said advertisement,
determining the time slots for broadcasting said advertisement,
validating the data introduced and the parameters defined in the preceding steps.

6. Communication tool according to claim 5, characterized in that said defining of a zone for broadcasting an advertisement is carried out by means of at least one tag or a circle or by selecting several zones.

7. Communication tool according to claim 6, characterized in that said formatting of said advertisement allows insertion of an image in any format or insertion of a video.

8. Communication tool according to claim 7, characterized in that said determining of the time slots for broadcasting said advertisement makes it possible to define the days and the times for broadcasting said advertisement.

9. Use of a communication tool according claim 8, for displaying advertisements directed at internet users.

10. Communication tool according to claim 5, characterized in that said formatting of said advertisement allows insertion of an image in any format or insertion of a video.

11. Communication tool according to claim 10, characterized in that said determining of the time slots for broadcasting said advertisement makes it possible to define the days and the times for broadcasting said advertisement.

12. Use of a communication tool according to claim 11, for displaying advertisements directed at internet users.

13. Communication tool according to claim 6, characterized in that said determining of the time slots for broadcasting said advertisement makes it possible to define the days and the times for broadcasting said advertisement.

14. Use of a communication tool according to claim 13, for displaying advertisements directed at internet users.

15. Communication tool according to claim 5, characterized in that said determining of the time slots for broadcasting said advertisement makes it possible to define the days and the times for broadcasting said advertisement.

16. Use of a communication tool according to claim 15, for displaying advertisements directed at internet users.

17. Use of a communication tool according to claim 5, for displaying advertisements directed at internet users.
